(19) United States
(12) Patent Application Publication
(10) Pub. No.: US 2009/0191902 A1
(43) Pub. Date: Jul. 30, 2009

(54) Text Scripting

(76) Inventor: John Osborne, Incline Village, NV (US)

Correspondence Address: IAN F. BURNS & ASSOCIATES, 4790 Caughlin Parkway #701, RENO, NV, 89519-0907, US

(21) Appl. No.: 12/273,211

(22) Filed: Nov. 18, 2008

Related U.S. Application Data
(60) Provisional application No. 61/023,768, filed on Jan. 25, 2008.
(60) Provisional application No. 61/035,790, filed on Mar. 12, 2008.
(60) Provisional application No. 61/079,672, filed on Jul. 10, 2008.

(51) Int. Cl. H04W 4/12

(52) U.S. Cl. 455/466

(57) ABSTRACT

A mobile telecommunications network is disclosed that allows a user to define a message script having a plurality of event fields. Tags may be associated with defined events and actions at the server end. A user may then transmit a message to the server with tag information in the message script format. The server processes the message to extract the tag information, lookup the events using the tags and perform the associated actions. In one particular example, fixed message content may be stored in the server and a message having fixed message content and variable message content may be sent to recipients by first sending a message script with tags and the variable content to the server.

### CROSS REFERENCE TO RELATED APPLICATIONS

This application claims priority to U.S. provisional patent application Ser. No. 61/023,768, filed Jan. 25, 2008, 61/035,790, filed Mar. 12, 2008 and 61/079,672, filed Jul. 10, 2008 the contents of which is herein incorporated by reference.

### FIELD OF THE INVENTION

The present invention relates to text messaging in telecommunications networks and in particular to providing a system and method for enhancing text messaging.

### BACKGROUND

Processor and memory capabilities of modern mobile telecommunications have lead to users relying on these devices for a range of applications other than telephone calls. Applications include storage of address book information, diaries, alarm clocks etc. In addition, text messaging, such as Short Message Service (SMS) and Multimedia Message Service (MMS) messages, has become a very common form of communication allowing texters to communicate at a convenient time to them, at lower expense and at a time irrespective of the availability of the recipient device.

However, one problem with current mobile applications is that they have very limited functionality and provide only point to point messages with no control.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to provide controlled text messaging events;

provide a delivery schedule;

allow a user to send message scripts with tagged actions;

allow a user to define a message script;

allow a user to define message actions;

allow a user to define message tags;

allow a user to generate group lists stored on a server for control events; and

provide an increased source of revenue for telecommunications operators.

These and other advantages may be realized by reference to the remaining portions of the specification, claims, and abstract.

### BRIEF DESCRIPTION OF ONE EMBODIMENT OF THE PRESENT INVENTION

In one aspect, the invention relates to a method of messaging on a mobile telecommunications network. In the method, a message comprising a message script is received in a server from a mobile telecommunications device. The message script is processed to determine one or more tags and one or more events associated with the tags. At least one action associated with the events is then performed.

In one aspect, the invention relates to a method of messaging on a mobile telecommunications network in which a message script and one or more tags are defined in a server. The one or more tags are associated with one or more messaging events. A message is generated in a mobile telecommunications device, the message comprising the message script with at least one tag. The generated message is transmitted from the mobile telecommunications device to the server.

In one aspect, the invention relates to a system for messaging on a mobile telecommunications network, the system comprising a server configured to receive a message from a mobile telecommunications device. The message may comprise a message script and the server may be configured to process the message script to determine one or more tags and determine one or more events associated with the one or more tags. The server is configured to then perform one or more actions in accordance with the one or more events.

In one aspect, the invention relates to a system of messaging on a mobile telecommunications network comprising means for defining a message script, means for defining one or more tags in the server, and means for associating the one or more tags with one or more messaging events. The system further includes means for generating a message in a mobile telecommunications device, the message comprising the message script with at least one of the tags. The system further includes means for transmitting the message from the mobile telecommunications device to the server.

The above description sets forth, rather broadly, a summary of at least one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a schematic view of one embodiment of a mobile telecommunications network of the present invention;

FIG. 2 substantially shows a flowchart of a method for messaging;

FIG. 3 substantially shows an example of an environment for defining a message script;

FIG. 4 substantially shows a further example of an environment for defining a message script with a recipient event;

FIG. 5 substantially shows an example of a message script with a user ID field and a script ID field;

FIG. 6 substantially shows an example of a message script for a game play environment; and

FIG. 7 substantially shows a further example of an environment for defining a message script.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention. Throughout the remainder of the description and in the claims that follow, the terms text message, text messaging, etc. will be used to distinguish messaging activities from voice activities. It will be apparent to the person skilled in the art familiar with such colloquial terms as “texting”, that text messages such as SMS, MMS and the like may include text only messages, messages with a combined text and other media, as well as messages containing no text per se.

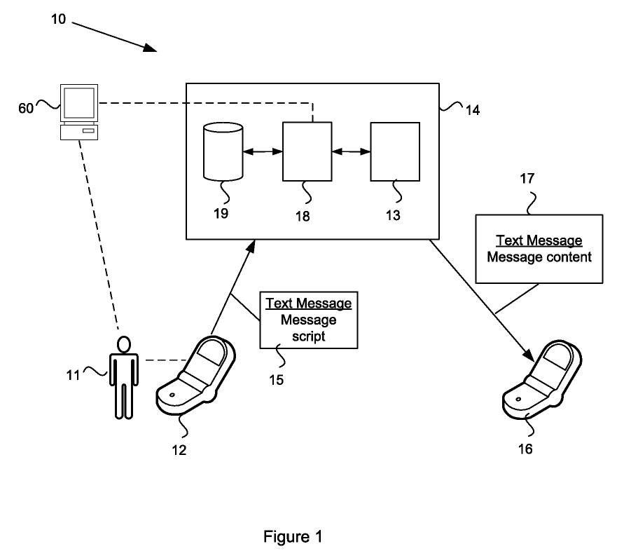

In FIG. 1, there is shown a mobile telecommunications network 10 in which a sender 11 operating a mobile telecommunications device 12 communicates with recipient devices 16 through a server network 14. The server network 14 includes a service provider such as a server 18, which may be a Short Message Service Centre (SMSC) with an associated database 19. The server network 14 may also include a scheduling system 13. The server 18 provides text messaging service such as Short Message Service (SMS) or Multimedia Message Service (MMS) from the sender 11 to recipient devices 16. While the sender device 12 is depicted as a mobile telephone, any device configured to provide text based messages may be used, including personal digital assistants, pagers, gaming devices, laptop computers, desktop computers, and the like.

In accordance with an embodiment of the invention, a user 11 may access the server 18 through an interface 60, which may be a web application, SMS application or similar. Through the interface 60, the user 11 is able to define one or more events and to associate one or more tags with the events. The user 11 may also define one or more actions taken in respect of the event. The user 11 may also define a script, which in one embodiment is a plurality of fields that contain the tags and other message information. In an alternative embodiment, standard format scripts may be selected by the user 11. Information defined and/or selected by the user may be stored in the database 19. The interface 60 may provide one or more forms that standardize the manner in which a user enters and defines information in the server.

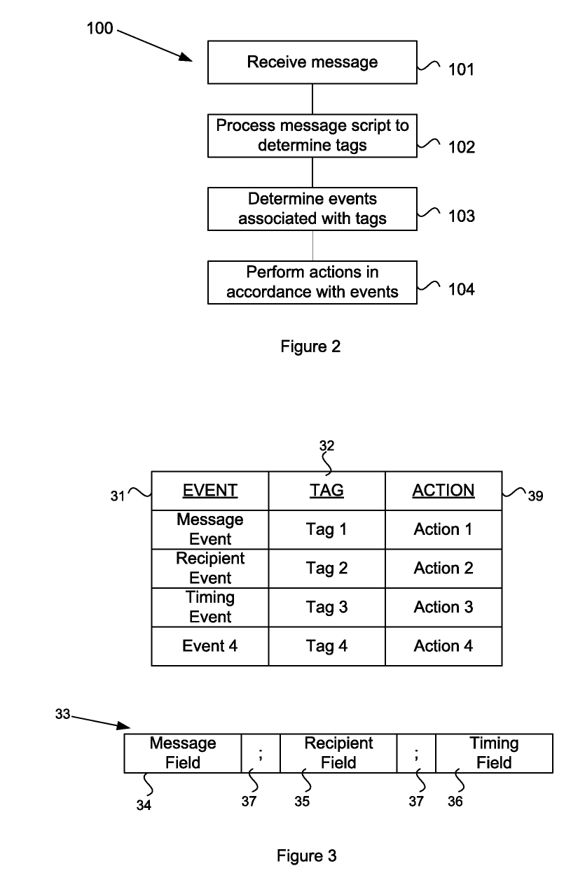

Once the message script, tags, actions and events have been suitably defined at the server end, the user 11 is able to send a SMS/MMS message 15 in the script format including the tag information. A method for messaging on the network 10 is depicted in the flowchart 100 of FIG. 2. When the server 18 receives the script message (step 101), the server 18 processes the script format to determine the tags contained in the script message (step 102). The server 18 then looks up the events and or actions associated with the extracted tags in the database 19 (step 103), e.g. using the tags as a lookup key, and performs the actions in accordance with the events (step 104). As shown in FIG. 1, an action may include generating a message 17 that includes message content produced in accordance with the tag information and sending the message 17 to a recipient device.

The script environment allows a user to create simple lists or lists and rules around personnel events, applications, group events, group notifications, control events, alarms, social notes, device interactions, game updates and the like.

An example of a script environment is illustrated in FIG. 3. The interface 60 of FIG. 1 allows the user to define a plurality of events 31 and to associate a plurality of tags 32 with the respective events. The user is also able to associate an action 39 with the event 31. The user is then able to define or select a script 33 which, as the example of FIG. 3 shows, may include a plurality of fields including such fields as a message field 34, a recipient event field 35 and a timing event field 36.

In defining a script, the user may also define a separator 37, examples of which include a comma (,), colon (:), semicolon (;), forward slash (/) or back slash (\). In the example of FIG. 3, a semicolon (;) is used as the separator 37. In addition to user-defined separators, system defined separators may also be used. Script messages 15 sent to the server 18 may only use the user defined separators and/or system defined separators as separators and not within the subject of a message. In an alternative embodiment, generation of scripts may be menu-driven from a user's mobile device. In such an embodiment, the need for separators within a text message can be removed. Instead, menu selections may allow a user to add new fields as required. Suitable coding understood by both the mobile device 12 and the server 18 may separate the fields when the SMS/MMS message is transmitted.

The user is then able to contact the server 18, for example using a short code, with a script message 15 containing a message portion, and one or more event fields with embedded tags separated by defined separators.

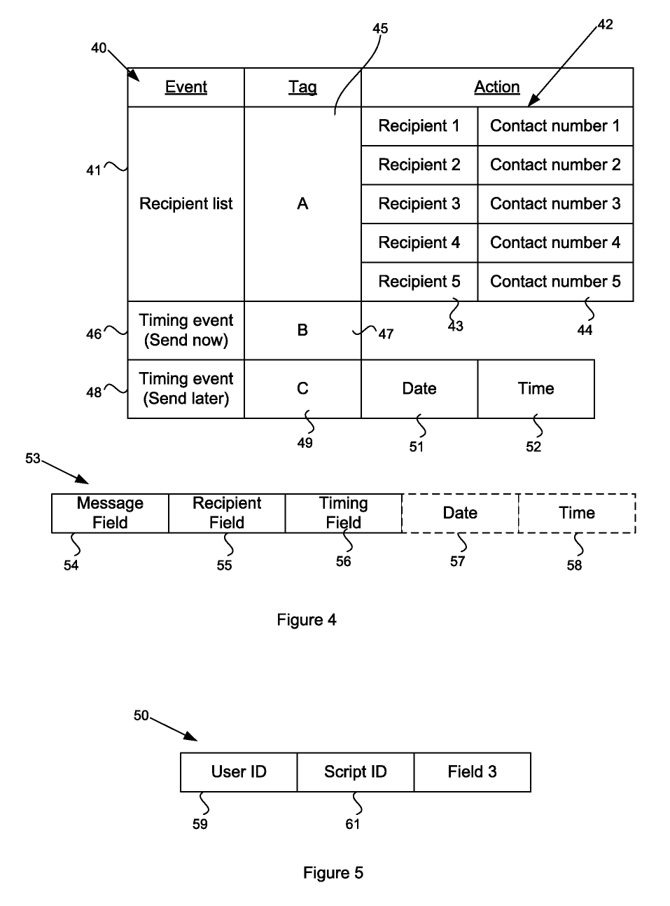

A specific example of the script environment is illustrated with reference to FIG. 4. An event table 40 is shown with events and their associated tags. A user defines a recipient event 41 which is a group or list 42 of contacts 43 with associated contact details 44, such as mobile telephone numbers, email addresses or other suitable contact information. The user tags the contact action with a tag “A” 45. The user then defines timing events. A first timing event 46 corresponds to a “send now” action and is assigned the tag “B” 47. A second timing event 48 corresponds to a “send later” action and is assigned the tag “C” 49. The “send later” timing event 49 has two conditional fields 51, 52 for specifying date and time information respectively. Date information may consist of a day, e.g. Monday, which may be interpreted as the next occurring Monday, or a complete date, e.g. in DD/MM/YYYY format, or any other suitable date format. Time information may be entered into the time field 52 in any suitable format, such as 12 hour time or 24 hour time. In addition, recurring date and time information may be entered, such as “every Monday”.

The user also defines a script 53 which includes a message content field 54, a recipient field 55, timing event field 56 and conditional timing fields 57, 58, shown in dotted outline, which are dependent on the tag or value included in timing event field 56.

At some later time, the user sends an SMS message to the server 18 with a message:

“meet at the beach at 4 today; A; B”

The server 18 processes the received script by first extracting the tag “A” in field 2 and retrieves the recipient list 42 from the database 19. The server 18 then processes the tag “B” in field 3 and determines that the message field (field 1) is to be sent now. Because the value of field 3 is tag “B”, i.e. “send now”, the server 18 does not look for any conditional field information. The server 18 thus generates a message with the message content of the message field (field 1), i.e. “meet at the beach at 4 today” and forwards the message to each of the entries in the contact list.

In a further example, again with reference to the script definitions of FIG. 4, the user may send an SMS message to the server 18 with a message:

“meet at the beach at 4 today; A; C; MO; 1530”

As for the previous example, the server 18 processes the received script and retrieves the recipient list identified by tag “A” provided in field 2. However, in this example, tag “C” of field 3 indicates a deferred text message is to be sent while fields 4 and 5 identify the conditional field information containing the delivery schedule. The server then extracts the delivery schedule information and creates a deferred message event in the scheduling system 13 for the specified time, i.e. Monday 3:30 pm. The deferred message event may include the message field, the recipients associated with the contact list identified by tag “A” and the delivery schedule. The scheduling system 13 processes the stored deferred message events and at the specified time, causes the server 18 to send a message to each of the entries on the group list containing the text “meet at the beach at 4 today”. If the message received from the user had contained “Tag C” in field 3, i.e. “send later”, but no delivery information was provided in field 4 and field 5, then the server 18 would return an error message to the user device 12.

With reference to FIG. 5, in one embodiment, a script 50 may include a user identification (ID) field 59. Part of the interaction between the user and server 18 through the interface 60 can include registering the user and assigning a user ID. The user ID allows the server 18 to identify the scripts defined by that user. In an alternative embodiment, the server 18 may identify the user using a device identifier such as the Mobile Subscriber Integrated Services Digital Network Number (MSISDN), SIM card identifier or similar. Because device identifiers are inherently transmitted as part of a regular SMS message, no additional field is required in the script. However, the use of an assigned user ID allows the user to send messages containing message scripts from any mobile telecommunications device or other device configured for text based messaging, such as a personal computer.

As is also shown in FIG. 5, the script 50 may include a script ID field 61. Using a script ID field 61 allows a user to have multiple scripts defined for that user. Alternatively, the script ID field 61 may be used to identify system scripts that can be used by any user. The script ID field 61 allows the server 18 to know the format of the script so that the server 18 is able to properly extract the tags and other information from the script fields.

The server 18 may be configured to provide response messages to the user. For example, an acknowledgement message may be provided to the sender device 12 if a script is received and processed without errors. In the case of deferred or scheduled text messages, an additional response message may be provided to the sender device 12 at the time that the deferred text messages are transmitted to the recipients. If the server 18 is unable to interpret a script received from a user, the server 18 may respond to the sender device 12 with an error message.

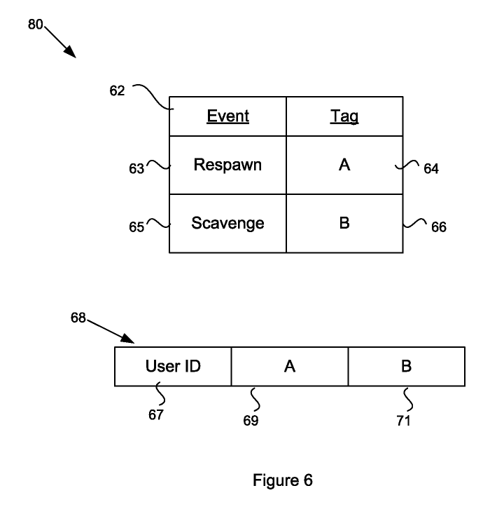

A further example relates to online game play via mobile web applications. In this example, a game player may want to check and amend the status of an online game. Within the server interface 60, a script may be defined as illustrated in FIG. 6. The script 80 includes an action/event table 62 in which events are associated with tags. Tag “A” 64 may be associated with the game related action “respawn” 63. Tag “B” 66 may be associated with the game related action “Scavenge” 65. The user may then set the status of an online character by sending the script message 68 “A; B” to the server 18. The server 18, which in this example may be a game play server, receives the script message and determines a game play character, for example from the device ID or a user ID 67 provided in the script. The user ID and/or device ID 67 may identify a game play character. The server 18 then extracts tag “A” of field 69 which causes the server 18 to perform the “respawn” action on the player's character. The server then extracts tag “B” of field 71 which causes the server 18 to perform the action associated with tag “B” by setting the status of the player's character to “scavenge”. Effects of these game play actions and game updates may be transmitted to the sender device 12 in subsequent text messages.

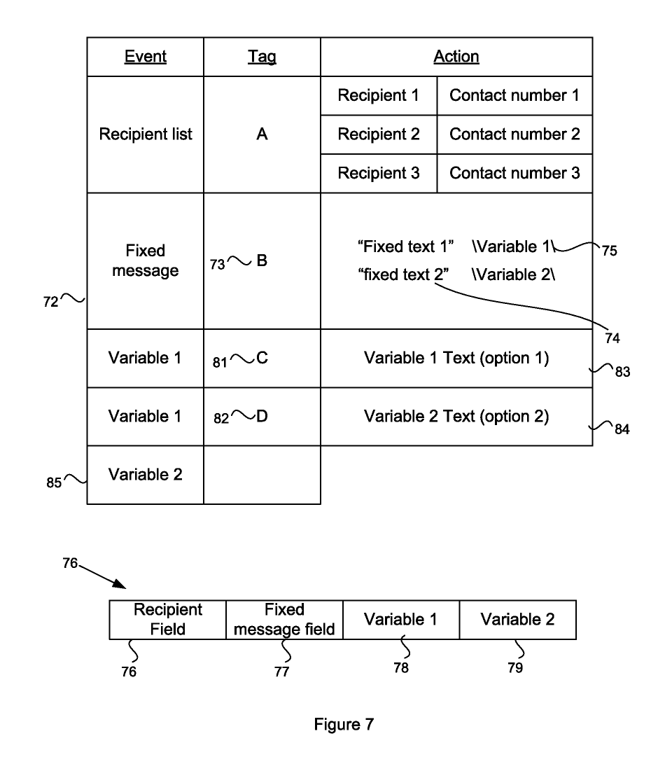

While the embodiments described above demonstrate relatively simple scripts, more complex scripts, actions, events and tags may be generated and utilized. In an embodiment illustrated in FIG. 7, a user may require to regularly send a standard message containing a fixed message portion and a variable message portion. The user may create the fixed message content as an event 72 within the server 18 and assign a tag 73 to the fixed message content event. The fixed message content 74 may be defined as an action associated with the event 72, with fields 75 within the fixed message content for variable message content. The user may then define a message script 76 with fields for the recipients 77, standard message 78 and variable parameters 78, 79. To send a message, the user need only create a message in their mobile telecommunications device 12 in the message script format with tags representing the recipients and standard message content and either tags or the specific information regarding the variable message content.

In the example of FIG. 7, Variable 1 may be defined in the event table with two possible options, each with a unique tag 81, 82 and a unique action 83, 84. The action performed for variable 1 is determined by the tag provided in the Variable 1 field of the message from the user. No action or tag is defined for the variable 2 event 85. Thus, when the message from the user is received, the server 18 will look to the content of the variable 2 field 79 and will use the field 79 content for completing the message.

An example of the message may be:

“A; B; D; Variable 2 text”

For this example, the server 18 would look up the fixed message content associated with tag B, supplement the variable message content associated with tag D for variable 1 and supplement the variable message content provided in the variable 2 field. A message using these forms of the fixed and variable message content would then be generated and transmitted to each recipient of the recipient list associated with tag A.

In a specific example, a manager of a sports team may define a recipient list of all team members with a tag such as T1. The user may define a message with tag M1 and with fixed message content such as “This week's game is on (Variable1) at (Variable2) at (Variable3). The Manager, Phone 5555 5555”. Variable 1 may represent a day, Variable 2 may represent a time and Variable 3 may represent a playing field location. Within the server 18, the user may also establish a list of playing fields, with additional information such as the address of the playing field, map reference, etc. Each playing field may be associated with a tag, such as F1, F2 etc. For example, field tag F2 may be associated with “Sportsfield 123” having an address of “XYZ Street, Sportsville” and map reference of “ABC”.

The user may further define a message script with a script ID code, such as “01” in the format:

Script ID : Recipient Tag : Fixed Message Tag : Variable 1 : Variable 2 : Variable 3 Tag

The manager may then send a message to the server using an appropriate short code, with the message as follows:

“01: T1: M1: Saturday: 1400: F2”

When the server 18 processes the script, the server 18 will send a message to each recipient within the T1 recipient list with the message content “This week's game is on Saturday at 2 pm at Sportsfield 123, XYZ Street, Sportsville, Map reference ABC. The Manager, Phone 5555 5555.”

Similar messages may be produced for training meetings etc, which may use the same script, but with different fixed message content identified by an alternative tag such as M2. Similarly, the manager may manage a second team but may use the same script by changing the recipient tag to an alternative tag such as T2 that might be associated with the second team.

It will be apparent to a person skilled in the art, that an advantage of the above described embodiments is that complex and detailed messages may be generated by a sender by creating relatively simple scripts, thus saving the sender considerable time.

For the above embodiments, the mobile telecommunications device 12 may be configured to provide a menu structure that allows a user to enter text messages in a message script format. Template scripts may be stored that prompt the user to enter all of the field information that is required. Times can be entered on a time entry page using the keypad of the mobile telecommunications device 12, for example, by entering a date in MM/DD/YYYY format and by entering a time in HH:MM:SS format. Other date and time formats will be apparent to the person skilled in the time and all date and time formats are considered to be equivalent. Times may be entered in the appropriate format by selecting numbers on the keypad or by scrolling up and down the time and date fields. Alternatively or in addition, the mobile telecommunications device 12 may display a calendar that allows the sender to select specific days and times.

While features such as the server 18, database 19 etc. are depicted as single blocks, the functions of these components may be performed by multiple components including one or more processors, memories and associated circuitry which may be co-located or provided in a distributed manner.

While the above embodiments make specific reference to mobile telecommunications devices, the person skilled in the art will recognize that non-mobile telecommunications devices may be used. In particular, it is known for some home telephone handsets as well as personal computers to offer the capability of transmitting text messages using the SMS/MMS networks. Such devices may be adapted to provide deferred text messaging as described in the above embodiments.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method of messaging on a mobile telecommunications network comprising:
(A) receiving a message from a mobile telecommunications device in a server, the message comprising a message script;
(B) processing the message script to determine one or more tags;
(C) determining one or more events associated with the one or more tags, the one or more events being associated with the one or more tags at a server end; and
(D) performing one or more actions in accordance with the one or more events.

2. The method of claim 1 wherein the script comprises message content and wherein at least one tag identifies a recipient list event that specifies one or more recipients, the method further comprising sending the message content to each of the one or more recipients.

3. The method of claim 2 wherein at least one tag identifies a timing event that specifies a message time, the method further comprising sending the message content to each of the one or more recipients at the message time.

4. The method of claim 1 wherein determining one or more events associated with the one or more tags comprises looking up the one or more tags in a database.

5. The method of claim 1 wherein at least one tag identifies a game play event.

6. The method of claim 4 further comprising defining the one or more tags.

7. The method of claim 6 further comprising associating the one or more tags with the one or more events.

8. The method of claim 1 wherein the script comprises one or more fields.

9. The method of claim 8 further comprising defining the one or more fields.

10. The method of claim 9 further comprising allowing a user to define at least one of the one or more fields at the server end.

11. The method of claim 8 wherein the one or more fields comprises at least one fixed message content field for a fixed message content portion and at least one variable message content field for a variable message content portion.

12. The method of claim 11 wherein the message comprises a fixed message content tag in the fixed message content field, the fixed message content field being associated with a fixed message content portion stored at the server end.

13. The method of claim 12 wherein the message comprises at least one of a variable message content portion in the at least one variable message content field or a variable message content tag in the at least one variable message content field, the variable message content tag being associated with a variable message content portion stored at the server end.

14. The method of claim 13 wherein performing one or more actions comprises:
(A) retrieving the fixed message content portion using the fixed message content tag;
(B) determining the variable message content portion;
(C) generating a transmission message comprising the fixed message content portion and the variable message content portion; and
(D) sending the transmission message to at least one recipient.

15. The method of claim 14 wherein determining the variable message content portion comprises retrieving the variable message content portion using the variable message content tag.

16. The method of claim 1 further comprising:
(A) providing an interface; and
(B) allowing a user to define at least one of the one or more tags or at least one of the one of more events at the server end through the interface.

17. The method of claim 1 further comprising:
(A) providing an interface; and
(B) allowing a user to define the message script at the server end through the interface.

18. A method of messaging on a mobile telecommunications network comprising:
(A) defining a message script in a server;
(B) defining one or more tags in the server;
(C) associating the one or more tags with one or more messaging events;
(D) generating a message in a mobile telecommunications device, the message comprising the message script, the message script comprising at least one of the one or more tags; and
(E) transmitting the message from the mobile telecommunications device to the server.

19. The method of claim 18 wherein generating a message comprises providing a tag associated with a fixed message content event in the server and providing a variable message content portion.

20. The method of claim 18 wherein generating a message comprises providing a tag associated with a timing event in the server.

21. The method of claim 20 wherein generating a message comprises providing a delivery time of the message.

22. The method according to claim 18 further comprising:
(A) processing the message script to determine one or more tags;
(B) determining one or more events associated with the one or more tags, the one or more message events being associated with the one or more tags at a server end; and
(C) performing one or more message actions dependent on the one or more message events.

23. A system for messaging on a mobile telecommunications network, the system comprising a server configured to:
(A) receive a message from a mobile telecommunications device, the message comprising a message script;
(B) process the message script to determine one or more tags;
(C) determine one or more events associated with the one or more tags; and
(D) perform one or more actions in accordance with the one or more events.

24. The system of claim 23 further comprising a database, wherein the server is configured to retrieve information from the database using the one or more tags.

25. A system of messaging on a mobile telecommunications network comprising:
(A) means for defining a message script;
(B) means for defining one or more tags in the server;
(C) means for associating the one or more tags with one or more messaging events;
(D) means for generating a message in a mobile telecommunications device, the message comprising the message script, the message script comprising at least one of the one or more tags; and
(E) means for transmitting the message from the mobile telecommunications device to the server.
